(19) United States
(12) Patent Application Publication
(10) Pub. No.: US 2022/0197549 A1
(43) Pub. Date: Jun. 23, 2022

(54) MEMORY CONTROLLER AND STORAGE DEVICE INCLUDING THE SAME

(71) Applicant: FADU Inc., Seoul (KR)

(72) Inventors: Yeong-Jae WOO, Guri-si (KR); Hongseok KIM, Seoul (KR); EHyun NAM, Seoul (KR)

(73) Assignee: FADU Inc., Seoul (KR)

(21) Appl. No.: 17/557,513

(22) Filed: Dec. 21, 2021

Related U.S. Application Data
(60) Provisional application No. 63/129,777, filed on Dec. 23, 2020.

(30) Foreign Application Priority Data
Dec. 23, 2020 (KR) 10-2020-0181895

(51) Int. Cl. G06F 3/06

(52) U.S. Cl. CPC G06F 3/0656; G06F 3/0679; G06F 3/0604

(57) ABSTRACT

A memory controller and a storage device including the same are provided. The memory controller is provided with an internal memory in addition to an external memory for write buffering, and may manage a buffer in different modes according to the write workload of a host.

### CROSS REFERENCE TO RELATED APPLICATIONS

This application claims the benefit under 35 USC 119(e) of U.S. Provisional Application No. 63/129,777 filed on Dec. 23, 2020, and claims the benefit under 35 USC 119(a) and 365(b) of Korean Patent Application No. 10-2020-0181895, filed on Dec. 23, 2020, in the Korean Intellectual Property Office, the entire disclosure of which is incorporated herein by reference for all purposes.

### BACKGROUND

### 1. Field

The disclosure relates to a memory controller and a storage device including the same, and more particularly, to a memory controller to which dynamic switching between write buffering modes is applied to reduce the frequency of accessing an external memory, and a storage device including the memory controller.

### 2. Description of Related Art

Semiconductor memories are categorized into volatile memory and non-volatile memory according to the storage mechanisms of information. Volatile memories include dynamic random access memory (DRAM) and static random access memory (SRAM). Although the volatile memory provides fast read and write speeds, the volatile memory loses stored information when it is powered off. In contrast, the non-volatile memory maintains its stored information even after it is powered off and thus is used to persistently store data irrespective of power-on or power-off. Non-volatile memories include erasable programmable read only memory (EPROM), electrically erasable programmable read only memory (EEPROM), ferroelectric RAM (FRAM), phase change RAM (PRAM), magnetoresistive RAM (MRAM), and flash memory. Particularly, the flash memory is widely used as an audio and video data storage medium for information devices such as a computer, a smartphone, a digital camera, a voice recorder, and a camcorder.

A flash storage device including such flash memory uses an external memory separately mounted outside a memory controller as a write buffer in order to increase the processing performance of a write request received from a host. However, when a high bandwidth memory (HBM) such as flash memory is used as a storage medium, a performance bottleneck may occur in the external memory. Because host data traffic to the external memory, which is generated during processing of a write request from the host, is too much for the storage medium, a performance bottleneck occurs in the external memory unless the bandwidth of the external memory is overwhelmingly larger than that of the storage medium. Moreover, since the external memory has various types of traffic such as software code execution and metadata access in addition to write buffering, the performance bottleneck is highly likely to occur. Further, when read/write is frequently performed on the external memory, power consumption increases due to input/output power.

Accordingly, there is thus a pressing need for a method of solving the conventional problem of a performance bottleneck and power consumption of an external memory in a flash storage device.

### SUMMARY

The disclosure has been made in an effort to solve the above-mentioned problems of the prior art, and an aspect of the disclosure is to provide a memory controller including an internal memory in addition to an external memory that performs write buffering, for managing a buffer in different modes according to the write workload of a host.

According to an embodiment of the disclosure, a memory controller for buffering write data in an external memory and programming the buffered write data to a non-volatile memory in response to a write request from a host includes an internal memory configured to buffer the write data therein, a buffer space identifier configured to identify the presence or absence of an idle buffer space for buffering the write data therein in the internal memory, and a buffering mode operator configured to, when the buffer space identifier identifies the presence of an idle buffer space, selectively perform a first mode operation of buffering the write data in the internal memory with priority over the external memory and a second mode operation of duplicately buffering the write data in each the internal memory and the external memory, based on the total amount of write data pre-buffered in each of the internal memory and the external memory.

In the memory controller according to an embodiment, when the absence of the idle buffer space is identified by the buffer space identifier, the buffering mode operator may buffer the write data only in the external memory, while skipping buffering of the write data in the internal memory.

The memory controller according to an embodiment may further include a buffer workload measurer configured to calculate the total amount of write data pre-buffered in each of the internal memory and the external memory.

In the memory controller according to an embodiment, the buffer workload measurer may be configured to calculate the total amount of pre-buffered write data except for write data duplicately buffered in one of the internal memory and the external memory in the second mode operation which has been performed.

In the memory controller according to an embodiment, when the total amount of pre-buffered data per predetermined period is less than or equal to a preset threshold, the buffering mode operator may be configured to perform the first mode operation, and when the total amount of pre-buffered data per predetermined period is larger than the preset threshold, the buffering mode operator may be configured to perform the second mode operation.

In the memory controller according to an embodiment, the threshold may be less than or equal to twice a maximum available buffering capacity of the internal memory per predetermined period.

The memory controller according to an embodiment may further include a processor configured to perform a flush operation to program the write data buffered in the internal memory and the external memory to the non-volatile memory.

In the memory controller according to an embodiment, the processor may be configured to transmit the write data duplicately buffered in the internal memory and release a buffer space occupied by the transmitted write data in the internal memory, and when programming of the transmitted write data is failed, transmit the write data duplicately buffered in the external memory to the non-volatile memory.

According to an embodiment of the disclosure, a storage device includes the above-described memory controller, an external memory configured to buffer write data therein in response to a write request from a host, and a non-volatile memory configured to program the buffered write data thereto.

In the storage device according to an embodiment, the non-volatile memory may be a flash memory.

The features and advantages of the disclosure will become more apparent from the following description based on the attached drawings.

The terms or words used in the specification and claims should not be interpreted in a conventional and lexical sense. Rather, they should be interpreted as meanings and concepts consistent with the technical idea of the disclosure based on the principle that the inventor can appropriately define the concept of terms in order to explain his or her invention in the best way.

According to the disclosure, a memory controller is provided with an internal memory having a buffer space in addition to an external memory for write buffering, and manages the buffers of the external memory and the internal memory through dynamic switching between different buffering mode. Therefore, the resulting minimization of the frequency of accessing the external memory may lead to prevention of a bottle neck and excessive power consumption of the external memory.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a memory controller according to an embodiment of the disclosure;

FIG. 2 is a block diagram illustrating the first mode operation and a second mode operation of the memory controller illustrated in FIG. 1;

FIG. 3 is a block diagram illustrating the first mode operation of the memory controller illustrated in FIG. 1;

FIG. 4 is a block diagram illustrating the second mode operation of the memory controller illustrated in FIG. 1;

FIG. 5 is a flowchart illustrating the first mode operation of the memory controller according to an embodiment of the disclosure;

FIG. 6 is a flowchart illustrating the second mode operation of the memory controller according to an embodiment of the disclosure;

FIG. 7 is a block diagram illustrating a storage device according to an embodiment of the disclosure; and

FIG. 8 is a block diagram illustrating a solid-state drive (SSD) to which the storage device is applied according to an embodiment of the disclosure.

### DETAILED DESCRIPTION

The objects, specific advantages, and novel features of the disclosure will become more apparent from the following detailed description and preferred embodiments, examples of which are illustrated in the accompanying drawings. The same reference numerals and signs denote the same or like components even when they are shown in different accompanying drawings from one another. The term as used in the disclosure, “1^{st}”, “2^{nd}”, “first” or “second” may be used for the names of various components, not limiting the components. These expressions are used only to distinguish one component from another component. Lest it should obscure the subject matter of the disclosure, a detailed description of well-known technologies is avoided.

Preferred embodiments of the disclosure will be described below in detail with reference to the attached drawings.

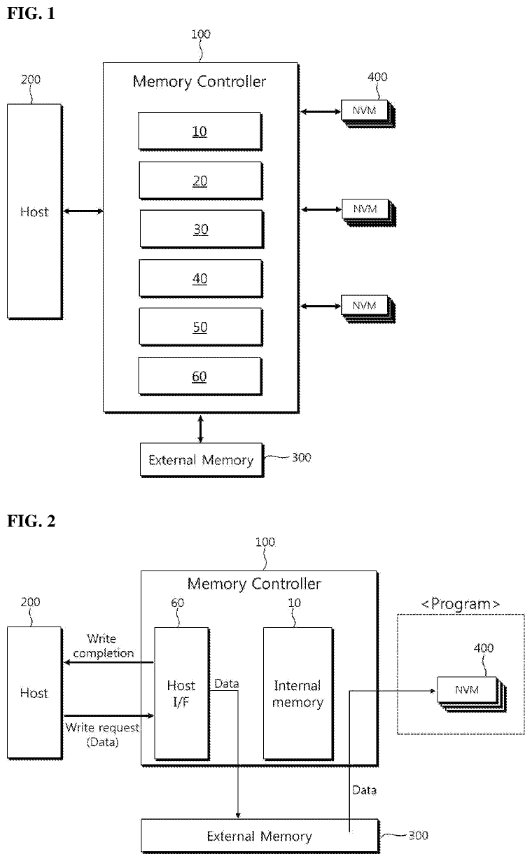

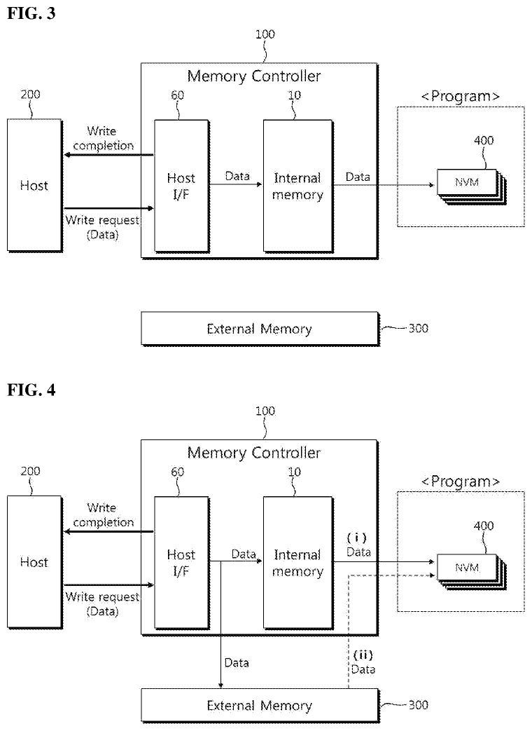

FIG. 1 is a block diagram illustrating a memory controller according to an embodiment of the disclosure, FIG. 2 is a block diagram illustrating a first mode operation and a second mode operation of the memory controller illustrated in FIG. 1, FIG. 3 is a block diagram illustrating the first mode operation of the memory controller illustrated in FIG. 1, and FIG. 4 is a block diagram illustrating the second mode operation of the memory controller illustrated in FIG. 1.

As illustrated in FIGS. 1 to 4, a memory controller 100 which buffers write data in an external memory 300 and programs the buffered write data to a non-volatile memory (NVM) 400 in response to a write request from a host 200 according to an embodiment of the disclosure includes an internal memory 10 which may buffer write data, a buffer space identifier 20 which identifies whether there is an idle buffer space for buffering write data in the internal memory 10, and a buffering mode operator 30 which selectively performs a first mode operation of buffering write data in the internal memory 10 with priority over the external memory 300 and a second mode operation of duplicately buffering write data in the external memory 300 and the internal memory 10.

The disclosure relates to a memory controller that controls at least one NVM. The NVM is a storage medium which is controlled by a memory controller and maintains its stored information data despite power-off. The NVM performs operations such as read and program operations in response to a command from the memory controller 100. Examples of the NVM 400 may include erasable programmable read only memory (EPROM), electrically erasable programmable read only memory (EEPROM), ferroelectric RAM (FRAM), phase change RAM (PRAM), magnetoresistive RAM (MRAM), and flash memory. A storage device employing an NVM as a medium uses a volatile external memory as a buffer in order to increase the processing performance of a read/write request from a host. However, because host data and various metadata traffic for the external memory is too large compared to host data traffic for the storage medium during processing of a write command from the host, a performance bottleneck may occur in the external memory. Moreover, when a read/write operation is frequently performed in the external memory, power consumption is significantly increased due to input/output power. In this context, the disclosure has been devised as a solution.

Specifically, the memory controller 100 according to an embodiment of the disclosure includes the internal memory 10, the buffer space identifier 20, and the buffering mode operator 30.

The memory controller 100 may further include a host interface 60 for providing an interface with the host 300. The host interface 60 may be connected to the host 200 through one or more channels or ports (not shown). For example, the host interface 60 may be connected to the host 200 through any one or all of a parallel AT attachment (PATA) bus, a serial AT attachment (SATA) bus, and a peripheral component interconnect express (PCIe) bus, or to the outside through a small computer system interface (SCSI), a universal serial bus (USB), or the like. A write request and/or a read request may be received from the host 200 through the host interface 60, and upon completion of a process corresponding to the request, a process completion response may be transmitted to the host 200.

The memory controller 100 according to an embodiment of the disclosure performs write buffering and buffer flush on the external memory 300 in response to a write request from the host 200. Upon receipt of the write request from the host 200, the memory controller 100 allocates a buffer space to the external memory 300, temporarily writes data of the host 200 in the allocated buffer space, and then transmits a write completion to the host 200. This operation is referred to as write buffering. To program the buffered data to the NVM 400, the memory controller 100 transmits a program command to a memory channel controller (not shown). Upon receipt of a program completion, the memory controller 100 writes a position at which the data has been stored to a mapping table, and releases the allocated buffer space. This operation is referred to as buffer flush. Since the completion is quickly transmitted to the host 200 through write buffering, a write latency is decreased. Buffer flush is performed in the background, which typically does not affect performance experienced by the host 200. However, when the buffer flush is too late, a space available to the external memory 300 is exhausted, thereby increasing a latency for a subsequent write command from the host 200.

In response to a read request from the host 200, the memory controller 100 determines whether data requested to be read exists in a buffer space. When the data exists in a buffer, the memory controller 100 transmits the data from the buffer to the host 200 and transmits a complication to the host 200. On the contrary, when the data does not exist in the buffer, the memory controller 100 obtains a physical address at which the data is located on the NVM 400 by referring to the mapping table, transmits a read command to the memory channel controller, and thus transmits the data of the NVM 400 and a completion to the host 200.

However, when the external memory 300 is used as a buffer as described above, a performance bottleneck and power consumption of the external memory 300 are problematic. The memory controller 100 according to the disclosure includes the internal memory 10 in addition to the external memory 300 and manages buffers through interworking between the buffer space identifier 20 and the buffering mode operator 30 according to the write workload of the host 200.

The internal memory 10 is a memory mounted inside the memory controller 100 according to the disclosure. The internal memory 10 may be implemented as a volatile random access memory (RAM), for example, a static RAM (SRAM) or the like. In addition, the internal memory 10 may include one or more memory blocks each corresponding to one region of the NVM 400, and may be built in the memory controller 100. Although the internal memory 10 typically has a smaller storage capacity than the external memory 300, the internal memory 10 has a large access speed and small power consumption. The internal memory 10 is used as a write buffer. Accordingly, when a write request is received through the host interface 60, write data to be programmed to the NVM 400 may be temporarily stored, that is, buffered in the internal memory 10 in response to the write request, under a predetermined condition. However, the internal memory 10 does not necessarily have to be used only as a write buffer, and may store data processed by software such as software code or various variables executed by a processor 50 to be described later. In addition, high-speed access to a data structure maintained in the low-speed NVM 400 is enabled. For example, the mapping table may be managed on the internal memory 10 and periodically dumped to the NVM 400. Further, when the NVM 400 is a flash memory, the internal memory 10 may be used as a driving memory for driving software called a flash translation layer (FTL).

The buffer space identifier 20 identifies whether write buffering in the internal memory 10 is possible. The internal memory 10 has a buffer space, and the buffer space identifier 20 identifies whether there is an idle buffer space in which write data corresponding to a received write request of the host 200 may be buffered. Because data for software processing and pre-buffered write data are stored in the internal memory 10, the buffer space identifier 20 first identifies whether an idle buffer space exists in the internal memory 10 in order to perform a write buffering operation.

The buffering mode operator 30 selects a buffering mode operation for buffering the corresponding write data in response to the received write request from the host 200. The buffering mode operation is divided into a first mode operation and a second mode operation, and one of them is selected according to a preset condition. According to the buffering mode operation, write data to be buffered is buffered in at least one of the internal memory 10 and the external memory 300. The buffering mode operation is selected based on the total amount of write data pre-buffered in each of the internal memory 10 and the external memory 300, which will be described later.

Specifically, when the buffer space identifier 20 identifies the absence of an idle buffer space available for buffering, buffering in the internal memory 10 may be skipped, and the write data may be buffered only in the external memory 300 in the first mode operation and the second mode operation (see FIG. 2). The memory controller 100 according to the disclosure may allocate a buffer space to the external memory 300, temporarily store the corresponding write data in the allocated buffer space, and transmit a write completion to the host 200. In addition, to program the buffered data to the NVM 400, the buffered data may be transmitted through the memory channel controller (not shown). When the programming is completed, the allocated buffer space may be released.

Referring to FIG. 3, in the first mode operation, when the buffer space identifier 20 identifies the existence of an idle buffer space in the internal memory 10, the corresponding write data is buffered in the internal memory 10 with priority over the external memory 300. A buffer space is allocated to the internal memory 10 and, the corresponding write data is buffered in the buffer space. Further, when the buffered data is programmed to the NVM 400 by a flush operation, the buffer space occupied by the data is released. Accordingly, when the idle buffer space of the internal memory 10 is sufficient, write data may be buffered in the idle buffer space without access to the external memory 300.

Referring to FIG. 4, in the second mode operation, when the buffer space identifier 20 identifies the existence of an idle buffer space in the internal memory 10, the corresponding write data is duplicately buffered in the internal memory 10 and the external memory 300. That is, the write data is temporarily stored in each of the internal memory 10 and the external memory 300. When a flush operation is performed to program the duplicately buffered write data to the NVM 400, the write data buffered in the internal memory 10 may be transmitted to the NVM 400, and the buffer space occupied by the transmitted write data in the internal memory 10 may be flushed. That is, regardless of whether programming of the write data transmitted from the internal memory 10 is successful, the buffer space allocated to the internal memory 10 for the write data is flushed. When programming of the write data transmitted from the internal memory 10 is successful, the write data duplicately buffered in the external memory 300 may be deleted, and the buffer space of the write data may be flushed. On the contrary, when programming of the write data transmitted from the internal memory 10 is failed, the programming operation may be re-performed by transmitting the duplicately buffered write data from the external memory 300, and when the programming is successful, the buffer space allocated to the external memory 300 may be flushed. Therefore, since the buffer space of the internal memory 10 is flushed early without the need for waiting for completion of the programming, the idle buffer space may be sufficiently secured in most cases. Further, since programming is rarely failed, the flush operation is performed mostly in the internal memory 10. Accordingly, compared to the case where only the external memory 300 is used as a buffer, the number of accesses to the external memory 300 may be reduced by about half.

The flush operation for programming write data buffered in the internal memory 10 and the external memory 300 to the NVM 400 may be processed by the processor 50. Accordingly, according to the first mode operation, write data buffered in the internal memory 10 having an idle buffer space or write data buffered in the external memory 300 due to the absence of an idle buffer space in the internal memory 10 is transmitted and programmed into the NVM 400 by the processor 50. In addition, in the second mode operation, write data buffered in each of the internal memory 10 and the external memory 300 having an idle buffer space or write data buffered in the external memory due to the absence of an idle buffer space in the internal memory 10 is also transmitted and programmed into the NVM 400 by the processor 50.

The processor 50 may be implemented as a micro-control unit (MCU), a central processing unit (CPU), or the like to process a request received from the host 200. The processor 50 may drive software to control internal functional blocks and the NVM 400. The driven software may be stored in the internal memory 10, and data required for driving the software may also be stored in the internal memory 10. However, the software and the data required for driving the software are not necessarily to be stored in the internal memory 10.

The memory controller 100 according to an embodiment of the disclosure may further include a buffer workload measurer 40. The buffer workload measurer 40 calculates the total amount of pre-buffered write data. Based on the calculated total amount of pre-buffered write data, the buffering mode operator 30 selects one of the first mode operation and the second mode operation for the write data to be buffered, and performs the buffering operation.

As described above, because the memory controller 100 according to the disclosure uses the internal memory 10 and the external memory 300 as buffers, when a write buffering operation is performed, write data is buffered in at least one of the internal memory 10 or the external memory 300. Accordingly, the buffer workload measurer 40 calculates the total amount of write data pre-buffered in each of the internal memory 10 and the external memory 300. When the second mode operation has been previously performed, the total amount of pre-buffered write data excluding the write data duplicately buffered in one of the internal memory 10 and the external memory 300 is calculated because the write data is duplicately buffered in the internal memory 10 and the external memory 300.

The buffering mode operator 30 dynamically switches the buffering mode to the first mode operation, when the write workload of the host 200 is low, and to the second mode operation when the write workload of the host 200 is high. That is, while the write workload of the host 200 is continuously monitored, and one of the first mode operation and the second mode operation is selected and maintained according to high workload or low workload, when the write workload changes, the buffering mode is dynamically switched to another mode operation according to the changed write workload.

The write workload of the host 200 is based on the total amount of write data pre-buffered in the internal memory 10 and the external memory 300. For example, the total amount of pre-buffered write data per predetermined period, that is, an average buffered amount is calculated and compared with a preset threshold. When the average buffered amount is equal to or less than or equal to the threshold, the first mode operation may be performed, and when the average buffered amount is larger than the threshold, the second mode operation may be performed. The period may be set to, but not limited to, 1 minute.

The threshold may be set to be equal to or larger than twice a maximum available buffering capacity of the internal memory 10 per predetermined period according to the following basis. As described above, the frequency of accessing the external memory 300 may be reduced by about half in the second mode operation, compared to the case of using only the external memory 300 as a buffer. In the first mode operation, when the total amount of pre-buffered write data is less than or equal to the write buffer capacity (hereinafter referred to as ‘K’, K>0) of the internal memory 10, the external memory 300 is not accessed. However, when the total amount of pre-buffered write data is K+M exceeding M (M>0) exceeding K, the external memory 300 is accessed for data corresponding to M out of the total K+M. Therefore, the ratio M/(K+M) of accesses to the external memory 300 in the first mode operation is compared with the ratio 1/2 of accesses to the external memory 300 in the second mode operation to distinguish high workload from low workload. When the two ratios are equal, which implies that M=K, the total amount of data K+M=2K. Accordingly, the threshold may be 2K or less. However, the threshold is not necessarily limited thereto.

The buffer space identifier 20, the buffering mode operator 30, and the buffer workload measurer 40 may be implemented in hardware or software. That is, they may be implemented in the form of digital or analog circuits located inside the memory controller 100 or implemented as separate chips or modules and connected to the memory controller 100. The buffer space identifier 20, the buffering mode operator 30, and the buffer workload measurer 40 may be implemented by storing and executing software in the internal memory 10 such as SRAM or a floppy disk or in the external memory 300 such as a compact disk or universal serial bus (USB). In addition, the buffer space identifier 20, the buffering mode operator 30, and the buffer workload measurer 40 may be implemented in a user-programmable form. Further, the buffer space identifier 20, the buffering mode operator 30, and the buffer workload measurer 40 it may be integrated into the processor 50.

In summary, the memory controller 100 according to the disclosure is provided with the internal memory 10 having a buffer space in addition to the external memory 300 for performing write buffering, and manages the buffers of the external memory 300 and the internal memory 10 through dynamic switching between different buffering modes according to the write workload of the host 200. Therefore, the resulting minimization of the frequency of accessing the external memory 300 may lead to prevention of a performance bottleneck and excessive power consumption of the external memory 300.

When the host interface 60 receives a read request from the host 200, the memory controller 100 according to the disclosure may primarily determine whether read data corresponding to the read request exists in the internal memory 10. In the presence of the read data, the memory controller 100 may transmit the read data to the host 200. In the absence of the read data in the internal memory 10, the memory controller 100 secondarily searches the external memory 300. In the presence of the read data in the external memory 300, the memory controller 100 may transmit the read data to the host 200, and in the absence of the read data in the external memory 300, the memory controller 100 may transmit the read data from the NVM 400 to the host 200. However, the buffer check order for the internal memory 10 and the external memory 300 is not necessarily limited to the above-described order, and the external memory 300 may first be checked, followed by the check of the internal memory 10. However, in the presence of data in both the internal memory 10 and the external memory 300, transmission of the data from the internal memory 10 is favorable, and thus the internal memory 10 is preferably first checked.

An operation method of the memory controller according to the disclosure will be described in more detail by separating the first mode operation from the second mode operation.

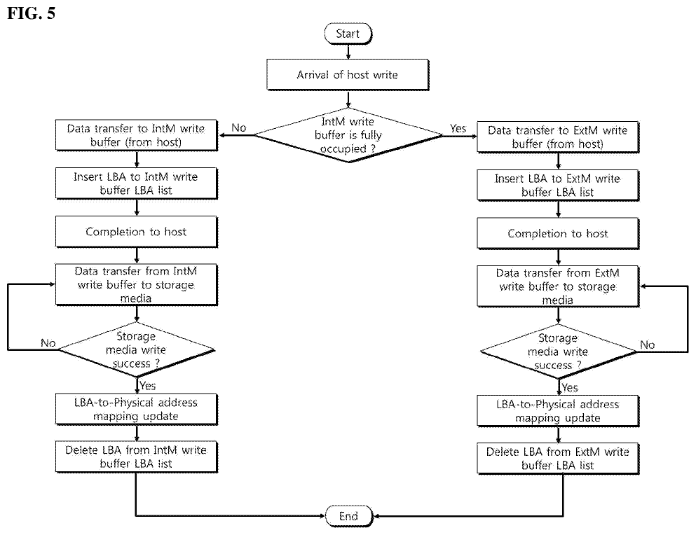

FIG. 5 is a flowchart illustrating the first mode operation of a memory controller according to an embodiment of the disclosure. Referring to FIG. 5, when the memory controller receives a write request in the first mode operation, it is checked whether the write buffer of an internal memory IntM is in a full state, that is, whether an idle buffer space exists in the internal memory IntM. When the write buffer of the internal memory IntM is not in the full state, a buffer area is allocated to the internal memory IntM, and write data corresponding to the write request is transmitted to the internal memory IntM. Subsequently, a logical block address (LBA) of the corresponding write data is inserted into the internal memory write buffer LBA list, and a processing completion is transmitted to the host. Then, the write data is transmitted from the write buffer of the internal memory IntM to the storage medium NVM, and written (programmed) to the storage medium. When the write data transmitted from the internal memory IntM is written (programmed) to the storage medium, LBA-to-physical address information is updated, and the LBA is deleted from the internal memory write buffer LBA list. On the contrary, when the write data transmitted from the internal memory IntM is not programmed, the programming operation is re-executed.

On the other hand, when the write buffer of the internal memory IntM is in the full state, the corresponding write data is transmitted to an external memory ExtM, and the above operation is performed in the same manner.

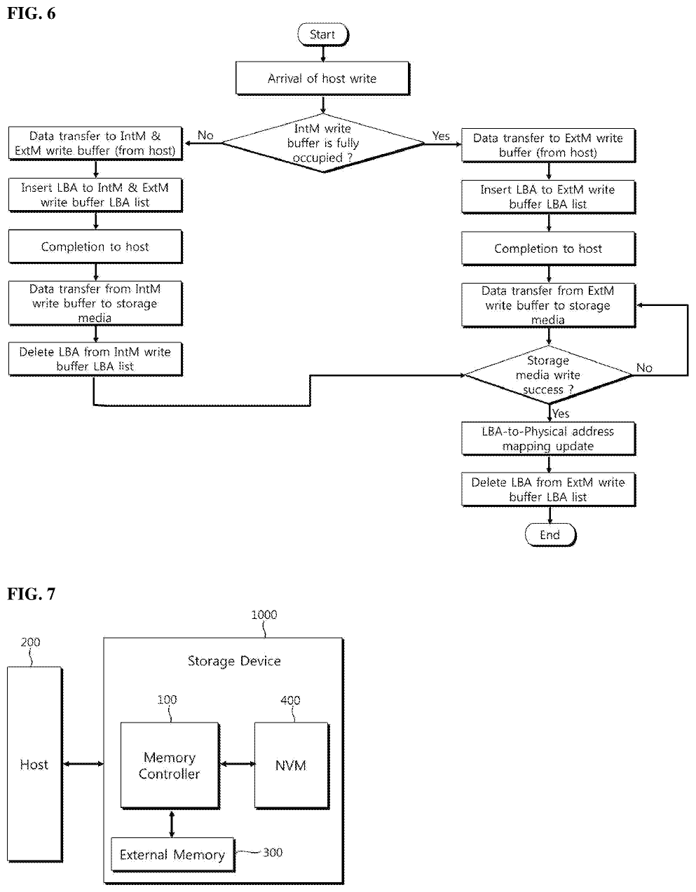

FIG. 6 is a flowchart illustrating the second mode operation of the memory controller according to an embodiment of the disclosure. Referring to FIG. 6, in the second mode operation, upon receipt of a write request, the memory controller checks whether a write buffer of an internal memory IntM is full occupied. When the internal memory IntM is not fully occupied, the memory controller allocates a buffer area to each of the internal memory IntM and an external memory ExtM, and transmits write data corresponding to the write request to the internal memory IntM and the external memory ExtM. Then, the memory controller inserts a logical block address (LB A) of the write data into an internal memory and external memory write buffer LBA list, and transmits a process completion response to the host. Then, the memory controller transmits the write data from the write buffer of the internal memory IntM to a storage medium NVM and write (program) the write data to the storage medium. In this case, the memory controller deletes the corresponding LBA from an internal memory write buffer LBA list without waiting until the write is completed. When the write data transmitted from the internal memory IntM is written (programmed) to the storage medium, the memory controller performs LBA-to-physical address information update and deletes the LBA from an external memory write buffer LBA list. When the write data transmitted from the internal memory IntM is not programmed, the memory controller transmits the write data from the external memory ExtM to the storage medium NVM and re-performs the programming operation. When the programming is successfully completed, the memory controller updates the LBA-to-physical address information update and then deletes the LBA from the external memory write buffer LBA list.

On the contrary, when the write buffer of the internal memory IntM is fully occupied, the memory controller transmits the write data to the external memory ExtM, inserts the LBA of the write data into the external memory write buffer LBA list, and then transmits a process completion response to the host. The memory controller then transmits the write data from the write buffer of the external memory ExtM to the storage medium NVM and writes (programs) the write data to the storage medium. When the write data transmitted from the external memory ExtM is written (programmed) to the storage medium, the memory controller performs LBA-to-physical address information update and deletes the LBA from the external memory write buffer LBA list. When the write data transmitted from the external memory ExtM is not programmed, the memory controller re-performs the programming operation.

The memory controller according to the disclosure may be applied to a storage device, which will be described below.

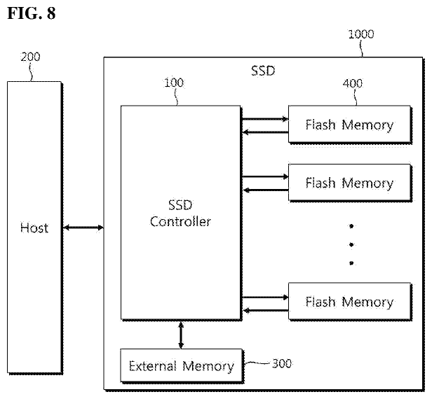

FIG. 7 is a block diagram illustrating a storage device according to an embodiment of the disclosure, and FIG. 8 is a block diagram illustrating an example of applying a storage device to a solid state drive (SSD) according to an embodiment of the disclosure.

As illustrated in FIG. 7, a storage device 1000 according to an embodiment of the disclosure may include the memory controller 100, an external memory 300 in which write data may be buffered in response to a write request from a host 200, and an NVM 400 to which the buffered write data is programmed.

The memory controller 100, the external memory 300, and the NVM 400 have been described before, and thus will not be described duplicately herein.

The storage device 1000 may include a memory card or a detachable storage device. The storage device 1000 is connected to the host 200 and exchanges data with the host 200 via a host interface. The storage device 1000 may receive power from the host 200 and perform an internal operation.

Further, referring to FIG. 8, the storage device 1000 according to the disclosure may be an SSD.

Since the SSD is connected to the host 200, the host 200 may write data to the SSD or read data stored in the SSD. The SSD may exchange signals with the host 200 via the host interface and receive power through a power connector. The SSD may include a plurality of NVMs 400 and an SSD controller. The NVMs 400 may be implemented as PRAM, MRAM, ReRAM, FRAM, or the like in addition to flash memory, and the plurality of NVMs 400 may be connected to the SSD controller through a plurality of channels. One or more NVMs 400 may be connected to one channel, and the NVMs 400 connected to one channel may be connected to the same data bus.

The memory controller 100 according to the disclosure is provided as an SSD controller and transmits and receives signals to and from the host 200 via the host interface. Commands, addresses, data, and so on may be transmitted in signals, and data is written to or read from a corresponding NVM 400 according to a command from the host 200.

While the disclosure has been described in detail with reference to specific embodiments, the embodiments are intended only for describing the disclosure, not limiting the disclosure. It is apparent to those skilled in the art that many variations or modifications can be made without departing the scope and spirit of the disclosure.

Simple modifications and changes of the disclosure fall within the scope of the disclosure and the specific protection scope of the disclosure will become apparent from the appended claims.

What is claimed is:

1. A memory controller for buffering write data in an external memory and programming the buffered write data to a non-volatile memory in response to a write request from a host, the memory controller comprising:
an internal memory configured to buffer the write data therein;
a buffer space identifier configured to identify the presence or absence of an idle buffer space for buffering the write data therein in the internal memory; and
a buffering mode operator configured to, when the buffer space identifier identifies the presence of an idle buffer space, selectively perform a first mode operation of buffering the write data in the internal memory with priority over the external memory and a second mode operation of duplicately buffering the write data in each the internal memory and the external memory, based on the total amount of write data pre-buffered in each of the internal memory and the external memory.

2. The memory controller according to claim 1, wherein when the absence of the idle buffer space is identified by the buffer space identifier, the buffering mode operator buffers the write data only in the external memory, while skipping buffering of the write data in the internal memory.

3. The memory controller according to claim 1, further comprising a buffer workload measurer configured to calculate the total amount of write data pre-buffered in each of the internal memory and the external memory.

4. The memory controller according to claim 3, wherein the buffer workload measurer is configured to calculate the total amount of pre-buffered write data except for write data duplicately buffered in one of the internal memory and the external memory in the second mode operation which has been performed.

5. The memory controller according to claim 1, wherein when the total amount of pre-buffered data per predetermined period is less than or equal to a preset threshold, the buffering mode operator is configured to perform the first mode operation, and when the total amount of pre-buffered data per predetermined period is larger than the preset threshold, the buffering mode operator is configured to perform the second mode operation.

6. The memory controller according to claim 5, wherein the threshold is less than or equal to twice a maximum available buffering capacity of the internal memory per predetermined period.

7. The memory controller according to claim 1, further comprising a processor configured to perform a flush operation to program the write data buffered in the internal memory and the external memory to the non-volatile memory.

8. The memory controller according to claim 7, wherein the processor is configured to:
transmit the write data duplicately buffered in the internal memory and release a buffer space occupied by the transmitted write data in the internal memory; and
when programming of the transmitted write data is failed, transmit the write data duplicately buffered in the external memory to the non-volatile memory.

9. A storage device comprising:
the memory controller according to claim 1;
an external memory configured to buffer write data therein in response to a write request from a host; and
a non-volatile memory configured to program the buffered write data thereto.

10. The storage device according to claim 9, wherein the non-volatile memory is a flash memory.
